(19) United States
(12) Patent Application Publication
(10) Pub. No.: US 2006/0181961 A1
(43) Pub. Date: Aug. 17, 2006

(54) Perishable item expiration timer

(76) Inventor: Lori B. Hobkirk, Boulder, CO (US)

Correspondence Address: SWANSON & BRATSCHUN L.L.C., 1745 SHEA CENTER DRIVE, SUITE 330, HIGHLANDS RANCH, CO, 80129, US

(21) Appl. No.: 11/057,505

(22) Filed: Feb. 14, 2005

(51) Int. Cl. G04B 47/00

(52) U.S. Cl. 368/10; 368/107

(57) ABSTRACT

A timer for displaying the conclusion of a first period of time after a perishable item has been placed into a container. Appropriate periods of time include 3 days, 7 days, or other time periods of any duration selected to correspond to the useful life of a perishable item. The timer includes a display, a first programming button permanently associated with the first period of time, and a timing processor electrically connected between the display and the first programming button. The timing processor may be configured to count the first period of time upon receipt of an input from the first programming button. The timing processor is further configured to cause the display to indicate the conclusion of the first period of time. The timer may include a housing which is selectively attachable to the container. Alternatively, the display, first programming button, and timing processor may be permanently integrated into either the lid or body of the container.

### TECHNICAL FIELD

The present invention is directed toward a device for managing the storage of perishable items, and more particularly toward a timing device with simplified programming functions associated with a perishable item container.

### BACKGROUND ART

Many types of containers are known for the storage of perishable items, such as leftover or unused food items. In use, a homemaker or restaurant owner will place a perishable item into a suitably sized container and then place the container into a refrigerator, freezer, or other suitable storage device. Typical storage containers are made of plastic and are available in various shapes and sizes.

Storage containers are useful because they are easy to stack and transport, thus organizing and segregating various types of perishable items. In addition, storage containers can extend the storage life of a perishable item. Typical storage containers provide an airtight seal between the perishable item and the outside environment, thus helping to preserve the perishable food item. In all cases, however, after a certain period of time, the perishable food item placed within the container will begin to spoil and become unsuitable for further use or consumption. The time period before a given perishable begins to spoil or otherwise becomes unusable will vary with the nature of the perishable food item.

Typically, leftover or surplus perishables are placed into containers and stored without any express provision made for monitoring or managing the likely expiration date for a given perishable. Thus, a homemaker or restaurant owner may often retrieve a storage container only to find that the contents have spoiled or become otherwise unusable. In extreme cases, the contents of the container may be contaminated and a health risk if consumed after a period of time. In addition, the physical inspection of the contents necessary to determine the suitability of the contents for consumption can cause the homemaker or restaurant owner to be exposed to foul and unpleasant smells and sights if spoilage has occurred.

Various devices are known which allow a homemaker or restaurant owner to manage perishable items placed in storage containers. Several types of containers featuring lids with manually dialed expiration date indicators are known. For example, Kramer, U.S. Pat. No. 3,818,858, teaches a container with a manually dialed date indicator. Kramer and similar art have no active countdown timing capability.

Another type of apparatus such as that taught by Reber, U.S. Pat. No. 5,969,606, and Quine, U.S. Pat. No. 6,795,376, feature sophisticated storage containers that incorporate at least one sensor which might be a humidity, temperature, or biological activity sensor which monitors the perishable food items placed within a container and dynamically adjusts a displayed expiration date. These types of devices are quite complex, and thus somewhat costly.

Fuchs, U.S. Pat. No. 6,664,887, teaches a simpler system for the management of perishable food items. Fuchs teaches a container that features a seal that is broken when the container is first opened. The breaking of the seal triggers a timer that measures elapsed time after the initial opening of the container. Thus, Fuchs is most relevant to newly purchased food products, and may not be particularly well suited to the management of leftover or surplus food items. Fuchs does not teach a simplified programming method where a user can select a period of time for expiration from multiple possible choices.

The present invention is directed toward overcoming one or more of the problems discussed above.

### SUMMARY OF THE INVENTION

One embodiment of the present invention is a timer for displaying the conclusion of a first period of time after a perishable item has been placed into a container. Appropriate periods of time include 3 days, 7 days, or other time periods of any duration selected to correspond to the useful life of a perishable item. The timer includes a display, a first programming button permanently associated with the first period of time, and a timing processor electrically connected between the display and the first programming button. The timing processor may be configured to count the first period of time upon receipt of an input from the first programming button. The timing processor is further configured to cause the display to indicate the conclusion of the first period of time. The timer may include a housing which is selectively attachable to the container. Alternatively, the display, first programming button, and timing processor may be permanently integrated into either the lid or body of the container.

Another embodiment of the invention is a timer which further includes a second programming button associated with a second period of time. The second programming button may be used to cause the timing processor to count the second period of time and display the conclusion of the second period of time.

Either embodiment of the timer may include a seal operatively associated with the timer to limit the exposure of electronic components to environmental moisture. Similarly, either embodiment of the invention described above may include a shield operatively associated with the timer configured to limit the exposure of electronic components to electromagnetic radiation.

The embodiment of the timer which features a housing selectively attachable to the container may also include a magnet operatively associated with the housing opposite the display. The magnet will allow storage of the timer separate from the container on a surface such as a refrigerator door.

Another embodiment of the present invention is a container including a body, a lid configured to mate with the body, and the elements of a timer which may be programmed as described above.

Another embodiment of the present invention is a container including a body and a lid configured to mate with the body and a timer substantially as described above. However, in this alternative embodiment, the first and optional second programming buttons are associated with a basic unit of time such as an hour or a day. Programming is accomplished by pressing a programming button multiple times. The timing processor of this embodiment is configured to count a select period of time upon receipt of an integer number of inputs from a programming button, which select period of time is equal to the integer number of basic units of time in the select period of time. As with other embodiments, the timing processor is further configured to cause the display to indicate the conclusion of the select period of time.

### BRIEF DESCRIPTION OF THE DRAWINGS

FIG. 1 is a perspective view of a container featuring an integrated timer consistent with the present invention;

FIG. 2 is a perspective view of an alternative style container featuring an integrated timer consistent with the present invention;

FIG. 3 is a perspective view of a timer having a housing which is selectively attachable to a container which is consistent with the present invention;

FIG. 4 is a schematic diagram of the electronic components of the present invention;

FIG. 5 is an exploded perspective view of a timer consistent with the present invention; and

FIG. 6 is a perspective view of a timer suitable for implementing the multiple push programming method of the present invention.

### DETAILED DESCRIPTION OF THE PREFERRED EMBODIMENT

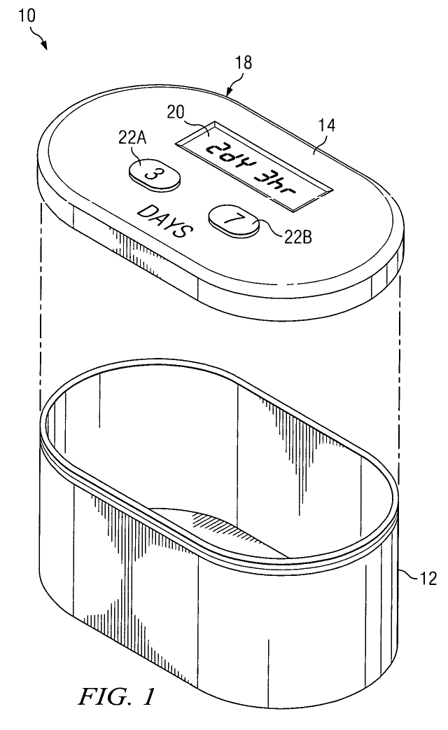

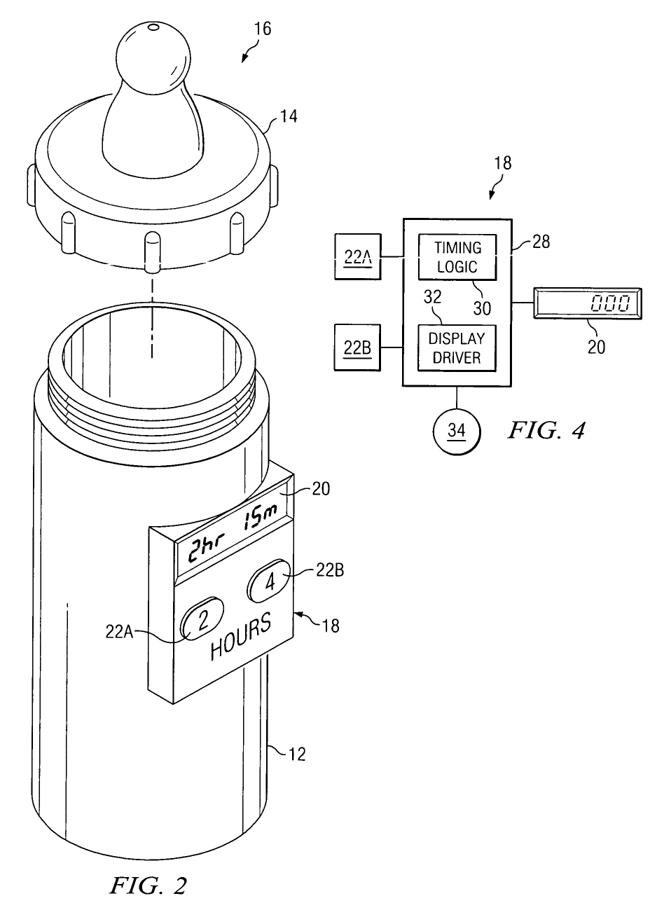

A container 10 for the storage of perishable items is shown in FIG. 1. The perishable item to be stored in the container 10 will typically be leftover or surplus food items or other materials which are subject to spoilage due to the actions of oxygen, microorganisms, humidity, or other agents. The container 10 shown in FIG. 1 includes a body 12 and a lid 14. Any other configuration of a container 10 with or without a lid 14 which is suitable for the storage of a perishable item is suitable for the implementation of the present invention. For example, the present invention may be implemented with a nontraditional container such as a baby bottle 16 as shown in FIG. 2.

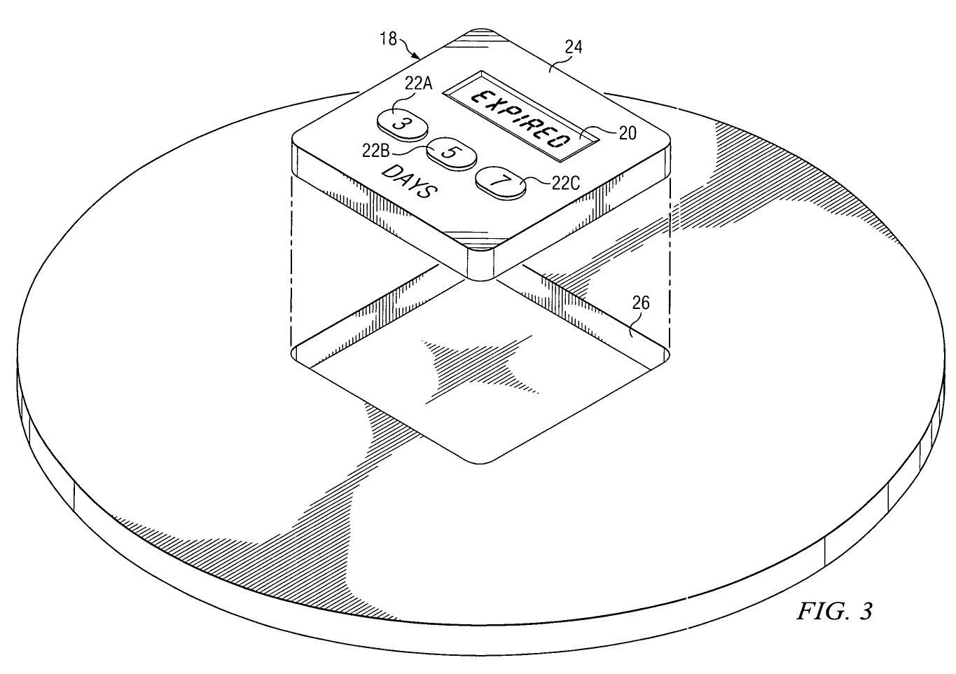

The container 10 includes a timer 18. The timer 18 may be associated with the lid 14 as shown in FIG. 1. Alternatively, the timer 18 may be associated with the body 12 as shown in FIG. 2. The timer 18 will include a display 20 and at least one programming button 22A associated with a specific time period. Other programming buttons 22B or, as shown in FIG. 3, 22C, may also be included. Any number of programming buttons are within the scope of the present invention. The use of the programming buttons 22A, 22B, 22C and display 20 is described in detail below.

In the embodiments shown in FIG. 1 and FIG. 2, the timer 18 is integrated into either the lid 14 or the body 12 of a container 10. Preferably, the timer 18 will be integrated into the container 10 by conventional plastic molding techniques in a sealed compartment which will provide access to programming buttons 22A, 22B, yet still limit exposure of the inner components of the timer 18 to environmental moisture.

Alternatively, as is shown in FIG. 3, the components of the timer 18 may be operatively disposed within a housing 24. Preferably, the timer 18 having a housing 24 will be selectively removable from the container 10. If the timer 18 is removable, the body 12 or lid 14 of the container 10 may be associated with a specific attachment structure 26 configured to releasably receive the housing 24 as shown in FIG. 3. The attachment structure 26 illustrated in FIG. 3 is a snap-fit receptacle sized to receive the housing 24. Alternative attachment structures are within the scope of the present invention including, but not limited to, snaps, buttons, sliding locks, magnets, hook and loop structures, or other similar releasable engagement mechanisms.

Certain components within the timer 18 are shown in schematic form in FIG. 4. Input to the timer 18 is provided by programming buttons 22A, 22B. A greater number of programming buttons 22A, 22B may be provided if desired. The programming buttons 22A, 22B may be any type of manual input button, key, or switch known in the electronic arts which can send a signal upon being depressed or otherwise actuated by a user. Buttons similar to those typically used with digital kitchen timers, calculators, or digital watches would be suitable for the implementation of programming buttons 22A, 22B.

Input from the programming buttons 22A, 22B is communicated electronically to a timing processor 28. The timing processor 28 will include digital processing circuitry and memory such as is typically used with digital kitchen timers or digital stopwatches. In particular, the timing processor 28 will include timing logic 30 and a display driver 32. Power may be supplied to the timing processor 28 through a battery 34. The timing processor 28 further communicates with the display 20.

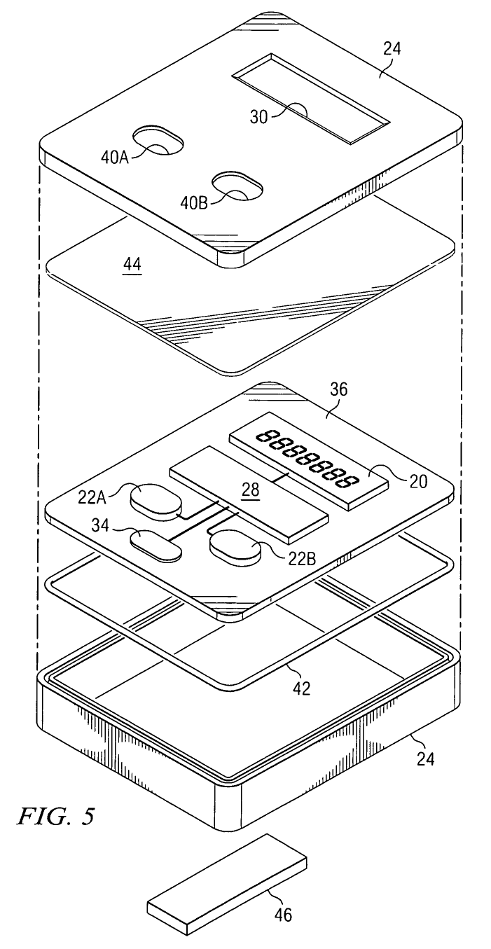

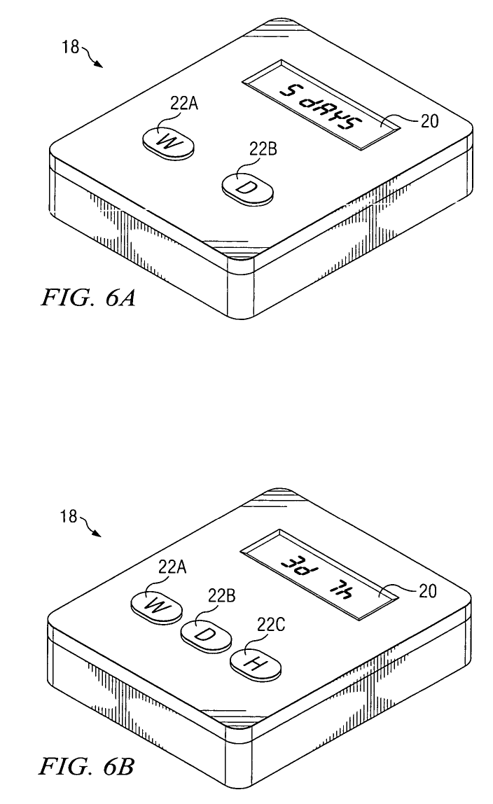

Preferably, the electronic components of FIG. 4 will be assembled on a printed circuit board 36 as shown in FIG. 5. As is also shown in FIG. 5, the housing 24 may include a window 38, button seals 40A, 40B, and a gasket 42. The window 38, button seals 40, and gasket 42 operate collectively with the housing 24 to limit the exposure of the electronic components associated with the timer 18 to environmental moisture.

As a result of the association of the timer 18 with a container 10 for perishable food items, it is possible that the components of the timer 18 will be exposed to microwave radiation in a microwave oven. Thus, it is preferable that a shield 44 be associated with the housing 24 to protect the electronic components from microwaves or other electromagnetic radiation.

In an embodiment of the timer 18 which is removable from the container 10, it is desirable to have a magnet 46 operatively associated with the housing 24 opposite the display 20. The magnet 46 will facilitate the storage of the timer 18 by attachment to a surface such as a refrigerator front panel during times when the timer is not attached to a container 10 and in use.

In a highly preferred embodiment, each programming button 22A, 22B, 22C is permanently associated with a select period of time. For example, in the embodiment shown in FIG. 1, programming button 22A is associated with a three day period of time and programming button 22B is associated with a seven day period of time. Longer or shorter periods may be selected by the manufacturer. For example, in the embodiment shown in FIG. 2, programming button 22A is associated with a two hour period of time and programming button 22B is associated with a four hour period of time. The embodiments of the timer 20 shown in FIGS. 1-3 are configured to use the “one button” programming method described below.

In a second embodiment, each programming button 22A, 22B, 22C is permanently associated with a basic unit of time as opposed to a select period of time. For example, in the embodiment shown in FIG. 6A, programming button 22A is associated with a week as a basic unit of time, and programming button 22B is associated with a day as a basic unit of time. Similarly, the timer 18 shown in FIG. 6B has three programming buttons 22A, 22B, 22C with each programming button 22A, 22B, 22C being associated with a basic unit of time. In the embodiment of the timer 18 depicted in FIG. 6B, programming button 22A is associated with a week, programming button 22B is associated with a day, and programming button 22C is associated with an hour. The embodiments of the timer depicted in FIG. 6A and FIG. 6B are configured to use the “multiple push” programming method described below.

During the countdown of the select period of time, whether programmed with a “one button” or “multiple push” programming method, the timing logic 30 in association with the display driver 32 may output to the display 20 an indication of the elapsed time since the programming button 22A was depressed. Alternatively, the timing logic 30 in association with the display driver 32 may output to the display 20 an indication of the remaining time in the select timing period as the timing sequence progresses. Upon expiration of the select time period, the timing logic 30 in conjunction with the display driver 32 may output to the display 20 a symbol such as “expired” or “old” or “end” indicating that the select time period has passed.

The embodiments of the timer 18 shown in FIGS. 1-3 are configured for programming by the one touch programming method. In the one touch programming method, each programming button 22A, 22B, 22C is permanently associated with a select period of time. For example, button 22B of FIG. 1 is permanently associated with a seven day period of time. Programming a timer 18 configured for use with the one touch programming method consists of depressing the appropriate programming button 22A, 22B, 22C once. For example, depressing programming button 22B of FIG. 1 once will initiate a seven day countdown sequence. Alternatively, the embodiment of the timer 18 shown in FIG. 6A and FIG. 6B is configured for use with a “multiple push” programming method. Each programming button 22A, 22B, 22C is associated with a basic unit of time in this embodiment. For example, programming button 22B of FIG. 6A and FIG. 6B is associated with a day. To program the timer 18 when configured in this embodiment, the homemaker presses the appropriate programming button 22A, 22B, 22C multiple times in sequence to set the appropriate overall countdown period. For example, if a homemaker or restaurant owner desires to program the timer 18 of FIG. 6A or FIG. 6B to countdown three days, he or she would depress programming button 22B three times in sequence. Thus, a timer 18 configured for use with the multiple push programming method offers more flexibility in the choice of countdown time durations. However, the multiple push programming method takes slightly more effort to program.

The display 20 is preferably an LCD display similar to that typically used with digital kitchen timers or digital wristwatches. Alternatively, the display 20 could show that the select time period has expired by lighting an LED, sounding an alarm, or initiating a suitable graphic representation.

In use, a homemaker or restaurant owner will first place leftover or surplus food items or other perishables into a suitably sized container 10 selected from those available for use. The homemaker or restaurant owner will determine an appropriate length of time for the storage of the particular perishable item at hand. For example, the homemaker or restaurant owner might determine that steamed vegetables have a useful storage life of three days, or that certain baked goods have a useful storage life of seven days. If steamed vegetables are placed in a container 10 such as that shown in FIG. 1, the homemaker or restaurant owner would seal the container 10 with an appropriate lid 14. If the homemaker is using a container 10 associated with a timer 18 which is configured to be programmed with the “one button” programming method, such as the timer shown in FIGS. 1-3, the homemaker or restaurant owner will press the programming button 22A associated with a three day time period. This action causes the timing processor 28 to begin counting down a three day period, upon the expiration of which the timing processor 28 will cause the display of a suitable word or symbol such as “expired.” During the countdown period, the display 20 may show the elapsed time or time remaining in the countdown period. Alternatively, if the homemaker selects a container 10 or timer 18 which is configured to be programmed by the multiple push method, such as the timer 18 shown in FIG. 6A or FIG. 6B, the homemaker or restaurant owner will push the “day” programming button 22B three times in sequence to initiate a three day countdown period.

Subsequently, when the homemaker or restaurant owner removes the container 10 from refrigerated or other storage, he or she may simply and quickly determine by examining the display 20 whether the perishable item stored within the container 10 is still good. Thus, the unpleasantness associated with opening a container of spoiled food may be avoided, the risk of food poisoning or disease may be minimized, and the efficient use of leftover or surplus food items can be efficiently managed.

If the homemaker or restaurant owner were storing baked goods, for example, he or she could use the same container 10 as described above, however, the programming button 22B associated with a seven day time period would be selected instead. Preferably, the homemaker or restaurant owner will have available a wide selection of containers 10 having programming buttons 22A, 22B associated with various applicable time periods.

In an embodiment where the timer 18 may be selectively removed and reattached to a container 10 such as is shown in FIG. 3, the homemaker or restaurant owner will have the additional flexibility of mixing and matching timers 18 having programming buttons 22A, 22B associated with various time periods with a selection of appropriately sized containers 10.

The sealing apparatus including the window 38, button seals 40, and gasket 42 will allow the timer 18 to be used with moist foods or washed while limiting the exposure of the electronic components associated with the timing processor 28 to environmental moisture. Similarly, an embodiment featuring a shield 44 may be used on a container 10 placed in the microwave oven with the shield 44 protecting the electronic components from electromagnetic radiation. In embodiments where the housing 24 is associated with a magnet 46, the timer 18 may be attached to a refrigerator or other metal surface for storage between uses.

The description of the present invention has been presented for purposes of illustration and description, but is not intended to be exhaustive or limiting of the invention to the form disclosed. The scope of the present invention is limited only by the scope of the following claims. Many modifications and variations will be apparent to those of ordinary skill in the art. The embodiment described and shown in the figures was chosen and described in order to best explain the principles of the invention, the practical application, and to enable others of ordinary skill in the art to understand the invention for various embodiments with various modifications as are suited to the particular use contemplated.

What is claimed is:

1. A timer for displaying the conclusion of a first period of time after a perishable item has been placed into a container comprising:
a display;
a first programming button associated with the first period of time; and
a timing processor in electrical communication with the display and the first programming button and configured to count the first period of time upon receipt of an input from the first programming button, the timing processor being further configured to cause the display to indicate the conclusion of the first period of time.

2. The timer of claim 1 further comprising a housing selectively attachable to the container, the housing containing the display, the first programming button and the timing processor.

3. The timer of claim 1 wherein the display, first programming button and timing processor are permanently integrated into one of a lid and a body of the container.

4. The timer of claim 1 further comprising a second programming button associated with a second period of time, wherein receipt of an input from the second programming button will cause the timing processor to count the second period of time.

5. The timer of claim 1 further comprising a seal operatively associated with the timer configured to limit the exposure of electronic components associated with the timing processor to environmental moisture.

6. The timer of claim 1 further comprising a shield operatively associated with the timer configured to limit the exposure of electronic components associated with the timing processor to electromagnetic radiation.

7. The timer of claim 2 further comprising a magnet operatively associated with the housing substantially opposite the display.

8. A container comprising:
a body;
a lid configured to mate with the body;
a display operatively associated with one of the lid and body;
a first programming button operatively associated with one of the lid and body, the first programming button being associated with a select period of time; and
a timing processor in electrical communication with the display and the first programming button, the timing processor being configured to count the select period of time upon receipt of an input from the first programming button, the timing processor being further configured to cause the display to indicate the conclusion of the select period of time.

9. The container of claim 8 further comprising a housing selectively attachable to one of the body and lid, the housing containing the display, the first programming button and the timing processor.

10. The container of claim 8 wherein the display, first programming button and timing processor are permanently integrated into one of a lid and a body.

11. The container of claim 8 further comprising a second programming button associated with a second select period of time, wherein receipt of an input from the second programming button will cause the timing processor to count the second select period of time.

12. The container of claim 8 further comprising a seal operatively associated with the timing pocessor configured to limit the exposure of electronic components associated with the timing processor to environmental moisture.

13. The container of claim 8 further comprising a shield operatively associated with the timing processor configured to limit the exposure of electronic components associated with the timing processor to electromagnetic radiation.

14. The container of claim 9 further comprising a magnet operatively associated with the housing substantially opposite the display.

15. A container comprising:
a body;
a lid configured to mate with the body;
a display operatively associated with one of the lid and body;
a first programming button operatively associated with one of the lid and body, the first programming button being associated with a basic unit of time;
a timing processor in electrical communication with the display and the first programming button, the timing processor being configured to count a select period of time upon receipt of an integer number of inputs from the first programming button which select period of time is equal to the integer number of basic units of time in the select period of time, the timing processor being further configured to cause the display to indicate the conclusion of the select period of time; and
a seal operatively associated with the timing processor configured to limit the exposure of electronic components associated with the timing processor to environmental moisture.

16. The container of claim 15 further comprising a housing selectively attachable to one of the body and lid, the housing containing the display, the first programming button and the timing processor.

17. The container of claim 15 wherein the display, first programming button and timing processor are permanently integrated into one of a lid and a body.

18. The container of claim 15 further comprising a second programming button associated with a second basic period of time, wherein receipt of an integer number of inputs from the second programming button will cause the timing processor to count a second select period of time which is equal to the integer number of basic units of time in the select period of time.

19. The container of claim 15 further comprising a shield operatively associated with the timing processor configured to limit the exposure of electronic components associated with the timing processor to electromagnetic radiation.

20. She device of claim 16 further comprising a magnet operatively associated with the housing substantially opposite the display.
